(19) United States
(12) Patent Application Publication
(10) Pub. No.: US 2012/0059686 A1
(43) Pub. Date: Mar. 8, 2012

(54) METHOD AND SYSTEM FOR RECOMMENDATION ENGINE OTIMIZATION

(76) Inventors: Kurtis G. Williams, Salt Lake City, UT (US); Frank H. Bria, Chandler, AZ (US)

(21) Appl. No.: 13/042,387

(22) Filed: Mar. 7, 2011

Related U.S. Application Data
(60) Provisional application No. 61/310,817, filed on Mar. 5, 2010.

(51) Int. Cl. G06Q 10/06

(52) U.S. Cl. 705/7.37

(57) ABSTRACT

A system and method for a process performed on a computer for constructing recommendation-based predictive models is disclosed. The system and methods access a collection of data records comprising a composite numerical representation of a primary performance indicator or PPI. The PPI comprises an ordinal data point having a calculated ordinal data level. A set of key drivers are determined having an influence on the PPI. Each of the key drivers comprises an ordinal data point having a calculated ordinal data level. An ordinal logistical regression is utilized to calculate the probability of increasing the PPI if each of the members of the set of key drivers are independently increased by a single ordinal data level. A recommended action from a user customizable candidate set of recommendations corresponding to the key driver having the highest probability of increasing the PPI is provided.

### PRIORITY CLAIM

This application claims priority to U.S. Provisional Application No. 61/310,817 filed on Mar. 5, 2010 and entitled “Method and System for Recommendation Engine Optimization” which is incorporated herein by reference in its entirety.

### FIELD OF THE INVENTION

The present invention relates generally to computer systems for making operational improvement recommendations. More particularly, the present invention relates to a customer feedback tool which assesses key areas that will have the greatest impact on increasing customer satisfaction.

### BACKGROUND

Customer feedback management is an increasingly important data tool in an increasingly information driven customer management environment. Every interaction a customer has with a company leaves a mark or an impression that they will most likely share with other customers. This experience may or may not be the brand that the company is promoting through its various marketing initiatives and may or may not have a positive impact on customer loyalty. Decision-makers that run and operate businesses use customer feedback to improve customer experiences thereby building loyalty and increasing revenues. As most modern decision-makers realize, the volume of available information surrounding business decisions is not always helpful. In many cases, decision-makers are forced to rely on myriad disparate sources of information, each having been gathered and structured in its own idiosyncratic way. Moreover, once this information is synchronized, its value and importance for result-driven decision-making is not always optimally or correctly evaluated.

Customer feedback can be collected in numerous ways including web surveys, phone surveys, mobile devices, and social media websites. Unfortunately, capturing feedback is often times the easiest step in customer feedback management. Converting customer feedback into useable intelligence and delivering that information to those who can properly implement that intelligence is difficult. Specifically, while nearly every aspect of the customer experience can be monitored and improved, some aspects of customer experience are more important than others and will have a greater impact on overall customer satisfaction. Thus there is a need for improved systems and methods for making decisions based on customer feedback to optimize customer satisfaction levels and improve customer loyalty.

### SUMMARY OF THE INVENTION

In light of the different problems and deficiencies inherent in the prior art, the present invention seeks to overcome these by providing a unique recommendation engine designed to optimize the selection of key driver impact on business primary performance indicators. The present invention resides in a method for a process performed on a computer for constructing recommendation-based predictive models, the method comprising accessing a collection of data records comprising a composite numerical representation of a primary performance indicator, wherein the primary performance indicator comprises data point having a calculated ordinal data level. The method further comprises determining a set of key drivers having an influence on the primary performance indicator, wherein each of the key drivers comprises an ordinal data point having a calculated ordinal data level and utilizing an algorithm based on the results of an ordinal logistical regression to determine the key driver that has the highest probability of changing the primary performance indicator. The method also comprises providing a recommended action from a user customizable candidate set of recommendations corresponding to the key driver having the highest probability of increasing the primary performance indicator.

The present invention also resides in a method for a process performed on a computer for constructing recommendation-based predictive models, the method comprising accessing a collection of data records comprising a composite numerical representation of customer satisfaction indices, wherein the customer satisfaction index comprises a data point having a calculated ordinal data level and determining at least two optimization goals for improving the customer satisfaction index, wherein the optimization goals can be used to compute an angle for comparison purposes. The method further comprises determining a set of at least two key drivers that influence the customer satisfaction index, wherein each of the key drivers comprises a data point having a calculated ordinal data level and utilizing an ordinal logistical regression to determine the key driver that has the highest probability of improving the customer satisfaction index, wherein each of the members of the set of key drivers are independently increased by a single ordinal data level. The method also comprises calculating the key driver performance of each key driver within each key driver metric and determining which key driver, if improved, most likely results in a value closest to the target angle.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a block diagram of the components of a recommendation engine system according to one embodiment of the invention;

FIG. 2 is diagram showing example target vectors projected onto a unit sphere in accordance with one embodiment of the invention; and

FIG. 3 is a diagram showing example predicted vectors compared to the target vectors of FIG. 2 in accordance with one embodiment of the invention.

### DETAILED DESCRIPTION OF THE INVENTION

Reference will now be made to, among other things, the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. Broadly stated, methods and apparatus for providing decision support systems to include customer satisfaction data analysis, assessment of key drivers related to customer satisfaction, predictions, and recommendations with consequences and optimal follow-up actions in specific situations are described.

Customer satisfaction data can be obtained from multiple disparate data sources, including in-store consumer surveys, post-sale online surveys, voice surveys, comment cards, social media, imported CRM data, and broader open market consumer polling, for example. Several factors are included in determining a composite score or numerical representation of customer satisfaction. Herein, that numeral representation is referred to as a Customer Satisfaction Index (“CSI”) or Primary Performance Indicator (“PPI”). There are a number of other methods for deriving a composite numerical representation of customer satisfaction that are contemplated for use in different embodiments of the present invention. For example, Net Promotor Score (NPS), Guest Loyalty Index (GSI), Overall Satisfaction (OSAT), Top Box, etc. are contemplated for use herein. This list is not exhaustive and many other methods exist to use mathematical methods to derive a numeric representation of satisfaction or loyalty would be apparent for use herein by one ordinary skill in the art. One object of the present invention is to determine optimal actions to increase the CSI for a particular situation. Data retrieved from customer feedback sources ranking their satisfaction with a particular service or product is compiled and used to calculate an aggregate score.

Primary performance indicators may be improved by either increasing or decreasing their value, depending on the intended use of the metric. For example, for some primary performance indicators it is desirable that the value actually decrease rather than increase. Such an indicator may track the number of mistakes made over time, in which case a lower value is desirable. Therefore, “improvement” in the primary performance indicator may mean a decrease in the value. In other cases the primary performance indicator may have a positive direction where a higher value is desirable. The recommendation system must support both cases.

The activities which will most likely have the greatest influence on the CSI, referred to as key drivers herein, are determined. Key driver analysis includes correlation, importance/performance mapping, and regression techniques. These techniques use historical data to mathematically demonstrate a link between the CSI (the dependent variable) and the key drivers (independent variables). Many of these techniques, however, include an inherent bias in that the analysis may not coincide with intuitive management decision-making. That is, key drivers that consistently show as needing the most improvement may not greatly increase the overall CSI. For example, the quality of food at a hospital may have a consistent low ranking on customer satisfaction feedback. However, that may not have any effect on a customer's decision to return to that hospital for his or her healthcare needs. The key is providing a prediction of which key driver will most likely increase overall CSI if that key driver is improved.

Key drivers may both increase and decrease the CSI, or both, depending on the particular driver. For example, if a bathroom is not clean, customers may give significantly lower CSI ratings. However, the same consumers may not provide significantly higher CSI ratings once the bathroom reaches a threshold level of cleanliness. That is, certain key drivers provide a diminishing rate of return. Other drivers may also be evaluated but that do not have a significant impact on CSI. For example, a restaurant may require the use of uniforms in order to convey a desired brand image. Although brand image may be very important to the business, it may not drive customer satisfaction and may be difficult to analyze statistically.

Once a CSI is determined and key drivers are identified, the importance of each key driver with respect to incremental improvements on the CSI is determined. That is, if drivers were rated from 1 to 5, moving an individual driver (e.g., quality) from a 2 to a 3 may be more important to the overall CSI than moving an individual driver (e.g., speed) from a 1 to a 2. When potential incremental improvement is estimated, key driver ratings for surveys are evaluated to determine the net change in the CSI based on incremental changes (either positive or negative) to key drivers. In one embodiment, once all of the surveys' CSI have been recomputed for each driver, the list of drivers is sorted by average improvement. In another embodiment, key driver values are selected based on an optimized CSI. That optimization may be determined with or without respect to cost of implementation.

Specific actions necessary to incrementally modify the key drivers are determined after an optimum key driver scheme is determined. Those actions, referred to as specific or standard operating procedures (“SOPs”), describe a particular remedial step connected with improving each driver, optimizing profit while maintaining a current CSI, or incrementally adjusting CSI to achieve a desired profit margin. In short, the SOPs constitute a set of user specified recommendations that will ultimately be provided via the system and method described herein to improve the CSI score.

In the description herein, details are given to provide an understanding of some embodiments of the present invention. However, it will be understood by one of ordinary skill in the art that the disclosed methods and apparatus may be practiced without the specific details of the example embodiments. It is also noted that certain aspects may be described as a process which is depicted as a flowchart, a flow diagram, a structure diagram, or a block diagram. Although a flowchart may describe the operations as a sequential process, many of the operations can be performed in parallel or concurrently and the process can be repeated. In addition, the order of operations may be re-arranged.

The methods and apparatus described herein may be used in connection with a network comprising a server, a storage component, and computer terminals as are known in the art. The server contains processing components and software and/or hardware components for implementing the recommendation engine. The server contains a processor for performing the related tasks of the recommendation engine and also contains internal memory for performing the necessary processing tasks. In addition, the server may be connected to an external storage component via the network. The processor is configured to execute one or more software applications to control the operation of the various modules of the server. The processor is also configured to access the internal memory of the server or the external storage to read and/or store data. The processor may be any conventional general purpose single or multi-chip processor as is known in the art.

The storage component contains memory for storing information used for performing the recommendation engine processes provided by the methods and apparatus described herein. Memory refers to electronic circuitry that allows information, typically computer data, to be stored and retrieved. Memory can refer to external devices or systems, for example, disk drives or other digital media. Memory can also refer to fast semiconductor storage, for example, Random Access Memory (RAM) or various forms of Read Only Memory (ROM) that are directly connected to the process.

Computer terminals represent any type of device that can access a computer network. Devices such as PDA's (personal digital assistants), cell phones, personal computers, lap top computers, tablet computers, or the like could be used. The computer terminals will typically have a display device and one or more input devices. The network may include any type of electronically connected group of computers including, for instance, Internet, Intranet, Local Area Networks (LAN), or Wide Area Networks (WAN). In addition, the connectivity to the network may be, for example, remote modem or Ethernet.

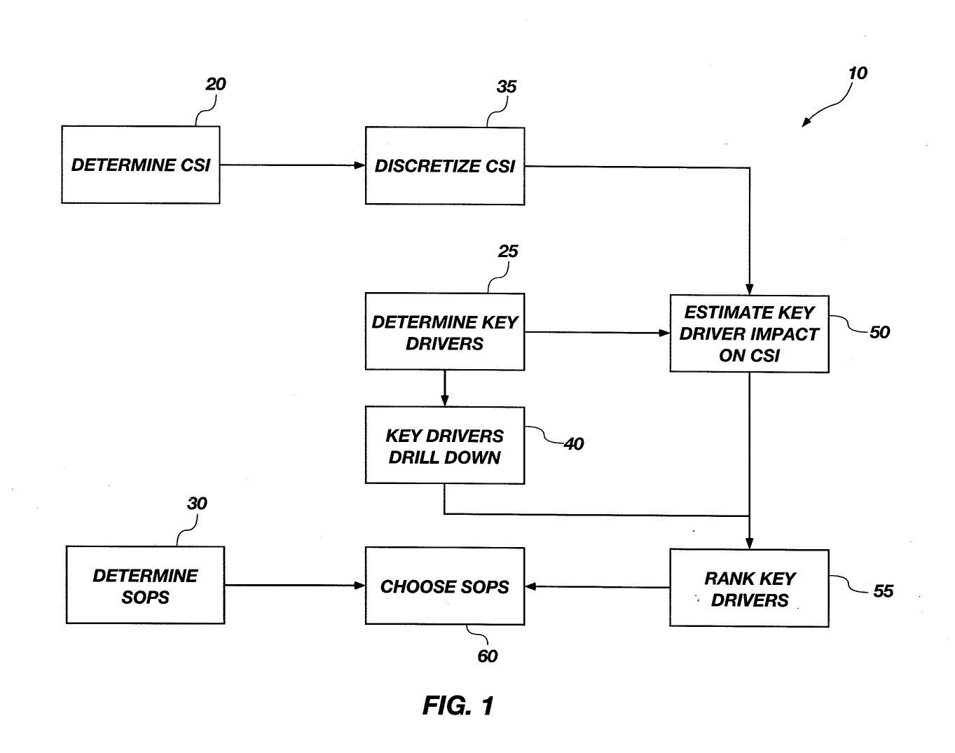

With specific reference to the figures, FIG. 1 is a block diagram illustration of certain blocks of the recommendation engine 10 described herein. At 20, a CSI is determined from relevant customer feedback information which has been provided from any number of sources and in any number of forms. For example, a survey may ask a consumer to rank a particular product from 1 to 10, or may ask a consumer to rank a service as poor, fair, good, or superior. In order to measure improvement to CSI, CSI scores are normalized and then discretized (shown at 35) into a predetermined range of numbers that fall between a predetermined minimum and maximum score. For example, if a CSI were normalized to a 100 point scale, it might be discretized into four groups or bins (0-25, 26-50, 50-75, and 76-100). Alternatively, it could be discretized into groups of five or ten, depending on the overall distribution of survey scores. In yet another example, CSI scores may be normalized simply as 1, 2, 3, 4, and 5. The discretization scheme is governed by the desire to model realistic improvements to the CSI in numerically meaningful increments.

In one aspect of the invention, the CSI is derived from one or more numeric data points such as a customer response to the question “Rate your intent to recommend us on a scale of 1 to 5,” or “Rate your overall satisfaction on a scale of 1 to 5”. CSI can also be derived from numeric data points discovered through data analysis such as text analytics. A mathematical formula such as a weighted average is used to compile the components into a single numeric value. For example, the CSI score for a sample (or survey) can comprise average ratings on satisfaction, intent to recommend, and intent to return. Rating questions of this kind are ordinal data points (as opposed to cardinal, nominal, or interval data points) in that they represent discrete values that have a specific directional order.

In accordance with one embodiment of the present invention, the CSI (or other key score) is chosen as the quantity to be optimized (i.e., the dependent variable). Other data points, including key drivers, are independent variables having properties that influence the dependent variable.

Referring now to call-out number 25, key drivers, the independent variables having the greatest influence on the CSI (other other key score) are determined and input into the process matrix. Examples of key drivers may include quality, service, atmosphere, and speed. These examples, however, are non-exhaustive and are subject to modification based on a business unit's particular needs and business goals. Similar to the rating questions, key drivers are also ordinal data points. They describe operational areas of improvement which can be tailored to each business unit's needs. An example of a key driver data set with example CSI scores is shown below in Table 1.

TABLE 1
Example Key Driver Data

| Sample # | CSI | Quality | Service | Atmosphere | Speed |
|---|---|---|---|---|---|
| 1 | 73.2 | 5 | 4 | 3 | 4 |
| 2 | 60.5 | 3 | 4 | 3 | 3 |
| 3 | 80.0 | 5 | 4 | 4 | 5 |

In one aspect of the invention, the independent variable data set may comprise additional explanatory properties referred to as key driver drill down data that further describe the ratings of each key driver. For example, a “Vehicle Cleanliness” key driver might have an explanatory property referred to as “Cleanliness Rating Explanation” with possible values including “exterior condition,” “interior condition,” and “interior door.” In one embodiment of the invention the drill down data comprises nominal data within the optimization engine as the data comprises textual labels that have no inherent numerical value or order. In another embodiment, the drill down data is given a numerical value to assist in the possible analysis of drill down data recommendation. An example of key driver drill down data is provided below in Table 2.

TABLE 2
Example Drill Down Data

| | | | Quality Drill | | Speed Drill |
|---|---|---|---|---|---|
| Sample # | CSI | Quality | Down | Speed | Down |
| 1 | 73.2 | 5 | [none] | 3 | Time to order |
| 2 | 60.5 | 3 | Food temp | 3 | Wait time |
| 3 | 40.0 | 2 | Food taste | 4 | [none] |

Each key driver represents an area of possible improvement of the CSI. Drill down properties, shown at numeral 35 on FIG. 1, comprise a subset of each key driver and provide the user with additional information regarding areas of focus related to the key driver itself. Each individual category from the drill down properties is considered separately. The number of times each category was chosen by the model as the drill down reason is then computed from the rows in the data set. All the drill down categories are then ranked by one of several ranking algorithms (most often occurring, marketing directives, cost adjusted occurrence, etc.). That is, while not required in certain embodiments of the invention, the drill down data is useful in selecting specified operational procedures to improve the ranking of the key driver and thus improve the overall CSI.

Specified or standard operational procedures (“SOPs”), shown at numeral 30 on FIG. 1, comprise textual entries representing an action that should be taken in response to a system recommendation. SOPs are determined and entered individually for each user as suits a particular business application. An SOP data set can contain recommendation text for key drivers or individual key-driver drill down. An example SOP data set is shown below in Table 3.

TABLE 3
Example SOP Data Set

| Key Driver | Drill Down | SOP |
|---|---|---|
| Cleanliness | [None] | Inspect work area for clutter and debris |
| | | Check storefront entryway |
| Cleanliness | Waiting or | Ensure product shelves are organized and |
| | retail area | free of dust |
| | | Inspect flooring, chairs, windows, and |
| | | shelves |
| Cleanliness | Stylist | Ensure hair has been vacuumed after each |
| | station | customer visit |
| | | Check sinks and countertops for organization |
| | | and debris accumulation |

Operational improvement analysis can be performed for any sized business and at any level of organization. In one embodiment of the invention, operational improvement recommendations are made for individual business units such as a single store, restaurant, or hotel. In another embodiment, recommendations are made for aggregate business units and can be made by region, state, country, etc. In one aspect of the invention, recommendations by way of comparison with other similar business units referred to as a peer comparison unit. An example peer comparison comprises a comparison of a single retail store against the average performance of other stores (individual or select aggregate units) in the region at specific dates and even specific times of day. In another aspect of the invention, business units may be compared to peer business units in different regions to assess differences in effectiveness of SOPs and/or key driver improvement implemented in different regions. For example, customer loyalty may be less affected in the southern part of the United States by improvement in certain key drivers for the same retail establishment in the northwest. Likewise, certain SOPs may have less of an effect on improving key drivers in the Canada as they may have in Mexico. Advantageously, the peer comparison analysis permits an owner of retail establishments spanning a broad territory to customize and analyze the effectiveness of a customer loyalty improvement scheme.

As noted above, recommendations are made for operational improvement based on how the performance of independent key driver influences the CSI. However, while key driver performance may be a primary metric in one embodiment, other embodiments include analysis of specific key driver metrics such as the ability of key driver's to influence the CSI or PPI, key driver consistency, peer comparison, costs, and profitability, for example, each of which can be used as independent variables.

In one embodiment of the invention, the recommendation engine 10 can be configured by determining a target value or prioritized mix between factors or key driver metrics to be optimized. In one embodiment, this is achieved by allocating points between all of the factors. For example, on a 10 point scale, 5 points may be allocated to performance, 3 to consistency, and 2 to cost, representing a fifty percent priority on performance, thirty percent priority on consistency, and twenty percent for cost, respectively. The target value or priority mix is then converted into a vector quantity yielding an “angle” than can be compared against other calculated angles. A similar vector can be computed for each sample in the customer satisfaction data, allowing aggregate comparisons against the target value. Two dimensions of goal-setting, consistency and performance, for example, may be represented by two points and an angle (i.e., a vector). Three dimensions of goal-setting (e.g., consistency, performance, and cost) may be represented by a three dimensional vector and four dimensional goal-setting by a four dimensional vector and so on.

In one embodiment of the invention, recommendation engine users choose a strategy (e.g., performance and consistency) and allocate 10 points between the two categories resulting in two target vectors. The resulting two target vectors are utilized to assess which key driver, if improved, most aligns with the strategy. An example target vector allocation is shown below in Table 4.

TABLE 4
Customer Target Vector

| | | | Angle | Angle |
|---|---|---|---|---|
| | Performance | Consistency | (Radians) | (Degrees) |
| Strategy 1 | 6 | 4 | 0.5880026 | 33.7 |
| Strategy 2 | 2 | 8 | 1.3258177 | 78.0 |

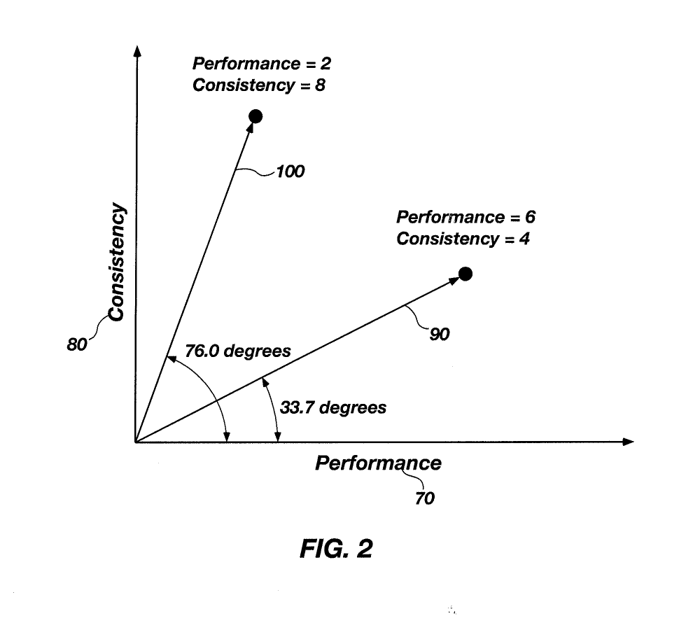

Referring now to FIG. 2, in accordance with one embodiment of the invention, in order to compare vectors together they are normalized by projecting the vector onto a unit sphere which comprises the set of points distance one from a fixed central point. This allows computation of the distance between vectors.

In one embodiment of the invention, ordinal logistic regression analysis is performed to calculate the probability of the target variable (e.g., the CSI) moving up or down by a predetermined level when one single key driver value moves up by a predetermined level. Put plainly, in one aspect of the invention ordinal logistic regression is used to determine which key driver has the highest probability of moving the target variable in the desired direction when one single driver value moves up one level. Here, it is important to note that different target variables are improved by increasing the value and others by decreasing the value, depending on the direction of the ordinal scale utilized to denote improvement. For example, in one embodiment customer satisfaction may be rated on a scale of 1 to 5 with one being poor and 5 being excellent. In another embodiment, 5 may be considered poor and 1 may be considered excellent.

The results of ordinal logistic regression is an array of “intercepts,” one for each dependent variable level, and an array of “parameters,” one for each driver variable level. For example, if the model contained CSI as the dependent variable and two drivers, a Friendliness Rating and a Quality Rating (all three on a five-point scale, e.g.), the results of an example ordinal logistic regression are presented in Table 5 below.

TABLE 5
Ordinal Logistical Regression Results

| Result Type | Term | Estimate |
|---|---|---|
| Target | Intercept[1] | 4.709 |
| | Intercept[2] | 6.165 |
| | Intercept[3] | 7.964 |
| | Intercept[4] | 10.488 |
| Driver | Friendliness[1-2] | −1.663 |
| | Friendliness[2-3] | −0.693 |
| | Friendliness[3-4] | −0.732 |
| | Friendliness[4-5] | −1.592 |
| Driver | Quality[1-2] | −1.156 |
| | Quality[2-3] | −0.336 |
| | Quality[3-4] | −0.482 |
| | Quality[4-5] | −0.583 |

There is one intercept for each possible value of the target value, except the highest value because it cannot be improved. There is one driver estimate for each possible movement (1 up to 2, 2 up to 3, etc.) in the driver value. In this way an intercept and driver estimate can be determined by finding the Intercept value that matches the target value and a driver estimate that matches the driver's value.

In one aspect of the invention, the probability of the target variable moving up by one when a single driver value moves up by one is represented by the formula:

$$ln \frac{p}{1 - p} = {Intercept}_{Target} + {Driver}_{Value}$$

where p is the probability of moving the target value up one level, Intercept_{Target} is the ordinal logistic intercept result for the target variable level, and Driver_{Value} is the ordinal logistic parameter result for the driver variable level. The ordinal logistic regression results in a set of intercepts and one set of parameter estimates for each key driver. That is, one estimate for each change in level.

Referring back to FIG. 1, for each row in a sample data set (such as that shown in Table 1) the change in the dependent variable score (e.g., the CSI) is predicted based on the movement of each key driver up one level. In one aspect of the invention, shown at numeral 50, this is completed row-by-row in the base data by comparing the value of all of the variables via the following formulas:

N=Intercept_{Target}+Driver_{Target}

where N is an intermediate variable containing the sum of the following two values, Intercept_{Target} is the ordinal logistic regression parameter for the target variable's level, and Driver_{Target} is the ordinal logistic regression parameter for the driver variable level.

$$p = \frac{{e}^{N}}{1 + {e}^{N}}$$

where p is the probability of increasing the target variable; and

Target_{new}=(1−p)Target_{old}+p(Target_{old}+1),if Target_{old}<max max Target,if Target_{old}

where Target_{new} is the possible new value of the target variable if the driver value is increased by one level and Target_{old} is the current value of the target variable (before improvement). Every row of data is recomputed in this manner resulting in a recomputed CSI score as if each driver had been improved by one level. Table 5 below is an example of recomputed CSI values based on improvement of each key driver by one level.

TABLE 5
Recomputed CSI data

| | | | | | | CSI | CS |
|---|---|---|---|---|---|---|---|
| | | | | | | from | from |
| | Inter- | Qual- | Quality | Friend- | Friendly | Qual- | Friend- |
| CSI | cept | ity | Param | ly | Param | ity + 1 | ly + 1 |
| 5 | | 5 | | 4 | −1.0097 | 5 | 5 |
| 3 | 7.9651 | 2 | −0.695 | 3 | −0.6129 | 3.99 | 3.99 |
| 1 | 4.7094 | 1 | −1.6643 | 1 | −1.599 | 1.99 | 1.99 |
| 4 | 10.4889 | 4 | −1.2053 | 4 | −1.0097 | 4.99 | 4.99 |

A new set of CSI average scores are now computed for each driver across the entire data set, similar to the baseline average CSI computation, except that the new recomputed “uplifted” score is used (average uplifted score for performance, standard deviation for consistency, ranking for peer comparison, etc.). In other words, for a starting set of samples there will be individual driver ratings and a computed CSI value. The baseline average is the average CSI over the entire set. A “new” CSI is computed as above for each sample. As a result, a “new” CSI average can be computed, one average for each driver. Example new improvement factor values are shown below in Table 6.

TABLE 6
New Improvement Factor Values

| | Improved CSI Mean | Standard Deviation |
|---|---|---|
| Quality | 3.99952886 | 1.41501436 |
| Friendly | 3.99949644 | 1.41506723 |
| Speed | 3.99923445 | 1.415454 |
| Cleanliness | 3.99863255 | 1.41663918 |
| Order Correctness | 3.49894622 | 1.29262765 |

Each value has its own scale and unit of measurement and thus cannot be directly compared to each other. Accordingly, each value is transformed into a standard z-score, a dimensionless quantity used to compare values. Means are transformed by the following formula as is known in the art:

$$\frac{{μ}_{target} - {μ}_{base}}{{σ}_{base}}$$

Standard deviations are transformed by the following formula as is known in the art:

$$\sqrt{2 n} \frac{{σ}_{base} - {σ}_{target}}{{σ}_{base}}$$

Table 7 below shows an example of standardized key driver values.

TABLE 7
Standardized Key Driver Values

| | Standardized | Standard |
|---|---|---|
| | “new” CSI Mean | Deviation |
| | (Performance) | (Consistency) |
| Quality | 0.438879 | 0.4849407 |
| Friendly | 0.438860 | 0.48485314 |
| Speed | 0.438707 | 0.48406121 |
| Cleanliness | 0.438354 | 0.48224975 |
| Order Correctness | 0.145768 | 0.68763235 |

It is possible that the only desired outcome is to increase the key driver performance with regard to CSI. In this case the driver with the highest “new” CSI is the driver that will most likely increase real CSI. However, in many cases it is desirable to compare improvement in CSI versus another measure such as consistency for example. In this manner, a user is able to “balance” its recommendation based on desired operational outcomes. Consistency is a measure of how closely together samples in the data set perform. For example, many restaurants desire a consistent quality rather than excellent for one customer and poor for the next. In this case a measure of consistency can be added as a dimension of the recommendation. Other examples of key driver metrics might include, but are not limited to, the cost of implementing key drivers, and the comparison of other peer operational units.

To use consistency (in addition to performance), for example, as an additional measure that influences the recommendation the following steps are added to the process. Once new scores are standardized, an angle is computed for comparison against a target angle (or vector). Referring again to FIG. 2, using the example factors of performance 70 and consistency 80, target angles would be computed using the following formula:

$$arctan \frac{Consistency}{Performance}$$

In one embodiment of the invention, a user may select a balanced operational outcome to be more heavily weighted towards consistency by providing a target value for consistency of eight and a target value of performance of two. The calculated target vector for such a combination is shown at 100. A user may also select a balanced operational outcome to be more heavily weighted towards performance by providing a target value for consistency of 4 and a target value of performance of 6. The calculated target vector for such a combination is shown at 90. Using the key driver analysis described above, comparison angles are computed using the same formula for computing target angles. An example of comparison angles for the newly computed key driver scores is presented below in Table 8.

TABLE 8
Comparison Angles

| | Angle | Angle |
|---|---|---|
| | (Radians) | (Degrees) |
| Quality | 0.83521678 | 47.8544 |
| Friendly | 0.83514846 | 47.8505 |
| Speed | 0.83450906 | 47.8139 |
| Cleanliness | 0.83304318 | 47.7299 |
| Order Correctness | 1.36190341 | 78.0314 |

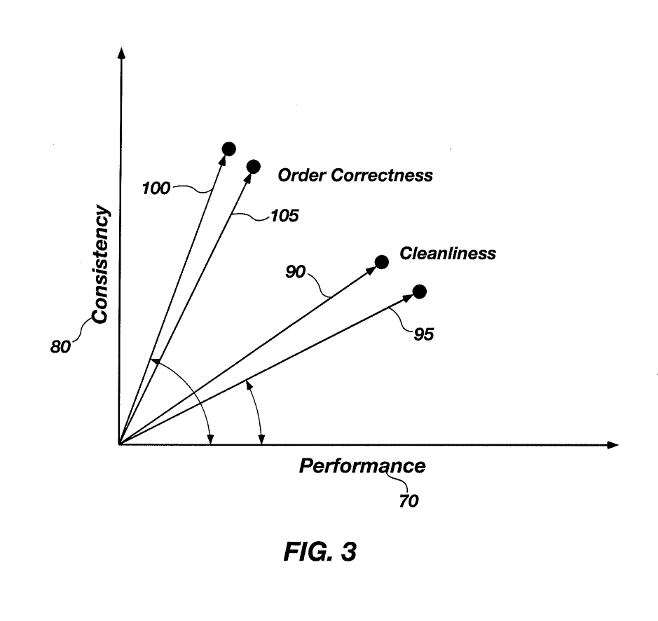

Shown at numeral 55 on FIG. 1, once comparison angles have been determined, the angle of the key driver which most closely aligns with the original target angle is selected. That is, key drivers are ranked based on the distance between its angle and the target angle determined from a particular business strategy. Referring now to FIG. 3, example results showing the two original strategies of performance 90 and consistency 100 is shown compared with the key driver metric which most closely aligns with the balanced operational outcome. In the upper strategy (i.e., more consistency than performance) and the above table, order correctness 105 is predicted as having the greatest impact driving the customer satisfaction score. In the lower strategy (i.e., more performance than consistency) cleanliness 95 is identified as the most important key driver. Advantageously, a business manager, or other user of the recommendation engine, may assess and evaluate the resulting effect different key drivers have on variable business strategies.

Additional measures for recommendation can be added into the weighted selection process by adding additional dimensions to the vector. The above example uses performance and consistency as the components of a two-dimensional vector. If cost were an additional consideration, it could be added as another dimension resulting in a three-dimensional vector.

In one embodiment of the invention, for each key driver, there may be one or more “drill-down properties”. A drill-down property is an additional explanatory data point that has been gathered to support the value of the key driver it is linked to. For example, for a key driver called “Vehicle Cleanliness Rating” there may be a nominal drill-down property with possible categorical values such as “exterior,” “interior,” “windows,” and “cargo area.” For an individual sample, the drill-down data explains why the driver rating was selected by the respondent. Each individual category from the drill-down properties is considered separately. The number of times each category was chosen as the drill-down reason is then computed from the rows in the data set. In one aspect, the drill-down categories are ranked by one of several ranking methods as suits a particular business decision. For example, the drill-down categories may be ranked by the most often occurring, least often occurring, marketing directives, cost adjusted occurrence, etc.

Shown at numeral 60, once the appropriate key driver has been identified and any drill-down data evaluated, SOPs are then recommended as the optimal actions for increasing the CSI as shown on Table. 3 above. The SOP library, or recommendation library, can be simple (i.e., limited to one entry per key driver or drill-down category) or very sophisticated (organized by brand or hierarchal business unit) depending on a particular business need. In one aspect of the invention, the SOP library lookup is keyed based on brand, hierarchy, key driver, and drill-down category. Businesses may contain one or more brands and within each brand there may be a reporting hierarchy (organization chart) of business units. For example, an automotive company may have a rental brand, a car parts retail brand, and a quick-lube service brand and within each of those brands would be a separate reporting hierarchy. Each brand and business unit may have unique goals shaped by business type, geography, demographics, etc. For example, a business may have three different types of retail facilities (fast-food restaurant franchises, fast-food delivery services to franchisees, and the preparation and packaging of fast-food products for franchisees). Each of those retail operations might have numerous locations spread out over different parts of the country and each may serve a different demographic. For example, the customers in one locale may be primarily young students attending a local college and the customers in another locale may constitute primarily retirees. Moreover, the retail operations may service business operations in the northeast (i.e., New York, Massachusetts, etc.) or the southwest (i.e., Arizona, Southern California). Each of these variations in demographics and geography, for example, require unique SOPs that are specifically tailored to a particular need. As a result of the aforementioned need, a custom set of SOP recommendations can be built for each key driver and drill-down category for a given brand, geography, demographic, etc., and then customized for each level in the organizational chart. If no SOP can be found for a drill-down category, or if no drill down category exists, a default key driver recommendation is given. The SOPs can also be keyed according to cost of implementation. In this manner, a business manager can evaluate which SOPs are likely to have the greatest influence on customer satisfaction for the least amount of money. In accordance with one embodiment of the invention, the recommendations made to the end user are based on a hierarchal lookup, keyed first on the key driver, next on a ranked explanatory attribute (i.e., drill-down data), if any, and finally on the business unit characteristics (e.g., geography, brand, service area, specific business unit). This allows a very finely-tuned and contextually unique SOP recommendation.

While the forgoing examples are illustrative of the principles of the present invention in one or more particular applications, it will be apparent to those of ordinary skill in the art that numerous modifications in form, usage, material selection and details of implementation can be made without the exercise of inventive faculty, and without departing from the principles and concepts of the invention. Accordingly, it is not intended that the invention be limited, except as by the claims.

1. A method for a process performed on a computer for constructing recommendation-based predictive models, the method comprising:
accessing a collection of data records comprising a composite numerical representation of a primary performance indicator, wherein the primary performance indicator comprises data point having a calculated ordinal data level;
determining a set of key drivers having an influence on the primary performance indicator, wherein each of the key drivers comprises an ordinal data point having a calculated ordinal data level;
utilizing an algorithm based on the results of an ordinal logistical regression to determine the key driver that has the highest probability of changing the primary performance indicator; and
providing a recommended action from a user customizable candidate set of recommendations corresponding to the key driver having the highest probability of increasing the primary performance indicator.

2. The method of claim 1, wherein the primary performance indicator comprises a customer satisfaction rating.

3. The method of claim 2, wherein the key drivers with greatest significance for improving the primary performance indicator are determined for separate operational units according to ranking criteria selected from one of customer geography, customer age, or customer income level.

4. The method of claim 1, wherein the step of determining a set of key drivers comprises accessing a collection of data records comprising a composite numerical representation of factors influencing the primary performance indicator.

5. The method of claim 1, wherein the ordinal data level of the primary performance indicator is calculated by discretion of continuous data points into ordinal data points.

6. The method of claim 1, wherein each member of the key set of drivers further comprises a subset of discrete nominal data points corresponding to different actions related to the key driver.

7. The method of claim 1, wherein each member of the key set of drivers further comprises a subset of discrete ordinal data points corresponding to different actions related to the primary performance indicator.

8. The method of claim 7, further comprising the step of utilizing an ordinal logistical regression to calculate which member of the subset of key drivers has the highest probability of improving the primary performance indicator wherein each of the members of the subset of key drivers are independently increased by a single ordinal data level.

9. A method for a process performed on a computer for constructing recommendation-based predictive models, the method comprising:
accessing a collection of data records comprising a composite numerical representation of customer satisfaction indices, wherein the customer satisfaction index comprises a data point having a calculated ordinal data level;
determining at least two optimization goals for improving the customer satisfaction index, wherein the optimization goals can be used to compute an angle for comparison purposes;
determining a set of at least two key drivers that influence the customer satisfaction index, wherein each of the key drivers comprises a data point having a calculated ordinal data level;
utilizing an ordinal logistical regression to determine the key driver that has the highest probability of improving the customer satisfaction index, wherein each of the members of the set of key drivers are independently increased by a single ordinal data level;
calculating the key driver performance of each key driver within each key driver metric; and
determining which key driver, if improved, most likely results in a value closest to the target angle.

10. The method of claim 9, wherein one or more optimization goals are to improve customer satisfaction performance, customer satisfaction consistency, or the cost of improving customer satisfaction.

11. The method of claim 9, wherein the method further comprises the step of allocating a numerical value to each of the one or more optimization goals such that the sum of the numerical allocation equals a whole number.

12. The method of claim 9, wherein the step of calculating a target level comprises allocating a predetermined number points between two or more optimization goals and calculating an angle resulting from the allocation by computing the arctangent of the first goal divided by the second goal.

13. The method of claim 9, further comprising accessing a user customizable candidate set of recommendations corresponding to the key driver and recommending an action having the greatest likelihood of improving the key drivers.

14. A computer implemented system for optimizing recommendation engine output, the system comprising:
means for accessing a collection of data records comprising a composite numerical representation of customer satisfaction index, wherein the customer satisfaction index comprises a data point having a calculated ordinal data level;
means for accessing a set of at least two key drivers, wherein the at least two key drivers are determined to have an impact on the customer satisfaction index and wherein each of the key drivers comprises an ordinal data point having a calculated ordinal data level;
means for utilizing an ordinal logistical regression to determine the key driver that has the highest probability of improving the customer satisfaction index wherein each of the members of the set of key drivers are independently increased by a single ordinal data level;
means for calculating a target level comprising a user-determined numerical combination of at least two key driver metrics;
means for calculating the key driver performance of each key driver within each key driver metric; and
means for determining which key driver, if implemented, most likely results in a value closest to the target value.

15. The system of claim 13, further comprising means for characterizing a subset of key drivers for separate operational units according to ranking criteria selected from one of customer geography, customer age, or customer income level.

16. The system of claim 13, wherein each member of the key set of drivers further comprises a subset of discrete ordinal numerical data points corresponding to different actions related to the primary performance indicator.

17. The method of claim 15, further comprising means for utilizing an ordinal logistical regression to calculate the probability of increasing the customer satisfaction index if each of the members of the subset of key drivers are independently increased by a single ordinal data level.

18. The method of claim 16, wherein the means for calculating a target level comprises allocating points between the two key driver metrics and calculating an angle resulting from the allocation by computing the arctangent of the first key driver metric divided by the second key driver metric.

19. The method of claim 16, further comprising accessing a user customizable candidate set of recommendations corresponding to the key driver and recommending an action having the greatest likelihood of improving the key drivers.

20. The method of claim 18, wherein the recommendations made to the end user are based on a hierarchal lookup keyed first on the key driver and second on one of business brand, business geography, or business operating unit.
